(19) United States
(12) Patent Application Publication
(10) Pub. No.: US 2026/0138333 A1
(43) Pub. Date: May 21, 2026

(54) ADDITIVE MANUFACTURING SYSTEM AND METHOD

(71) Applicant: Honeywell Federal Manufacturing & Technologies, LLC, Kansas City, MO (US)

(72) Inventor: Neiko Phillip Levenhagen, Lee's Summit, MO (US)

(21) Appl. No.: 19/392,510

(22) Filed: Nov. 18, 2025

Related U.S. Application Data
(60) Provisional application No. 63/721,656, filed on Nov. 18, 2024.

(51) Int. Cl. B29C 64/336; B29C 64/171; B29L 31/34; B33Y 10/00; B33Y 30/00; B33Y 80/00

(52) U.S. Cl. CPC B29C 64/336; B29C 64/171; B29L 2031/34; B33Y 10/00; B33Y 30/00; B33Y 80/00

(57) ABSTRACT

An additive manufacturing system and method for forming a modular electronic assembly including first and second modular electronic components. The system includes first, second, and third material reserves, first, second, and third material applicators, a directed energy head, and a processor. The first material applicator deposits additive manufacturing material to form substrates of the modular electronic components. The second material applicator deposits conductive material on the substrates thereby forming conductive traces. The third material applicator deposits the solder material thereby forming solder points on the first modular electronic component and the second modular electronic component. The directed energy head heats the solder material so that solder points of the first modular electronic component join solder points of the second modular electronic component. The processor controls the material applicators and the directed energy head according to a computer-aided design.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/721,656, titled “ADDITIVE MANUFACTURING SYSTEM AND METHOD”, and filed Nov. 18, 2024. The Provisional Application is hereby incorporated by reference, in its entirety, into the present patent application.

### GOVERNMENT INTERESTS

This invention was made with Government support under Contract No.: DE-NA-0002839 awarded by the United States Department of Energy/National Nuclear Security Administration. The Government has certain rights in the invention.

### BACKGROUND

Modular electronic components and assemblies are often formed via additive manufacturing, which has evolved to include multi-material and modal technology for building substrates and electrical traces and actively curing them within a single additive manufacturing system. Unfortunately, joining modular electronic components to form assemblies still relies on connectors and cables, which take up significant space and are prominent failure points.

### SUMMARY

The present invention solves the above-described problems and other problems by providing an additive manufacturing system and methods for directed energy assisted soldering to form additively manufactured modular assemblies. In particular, the present invention forms modular electronic components including solder points that act as electronic connections and mechanically join the modular electronic components together.

An embodiment of the invention is an additive manufacturing system configured to form a modular electronic assembly including first and second modular electronic components. The additive manufacturing system broadly comprises a frame, a support surface positioned on the frame, a first material reserve, a first material applicator, a second material reserve, a second material applicator, a third material reserve, a third material applicator, a directed energy head, and a processor. The first material reserve is configured to supply an additive manufacturing material to the first material applicator, which is configured to deposit the additive manufacturing material to form substrates of the first modular electronic component and the second modular electronic component on the support surface. The second material reserve is configured to supply a conductive material to the second material applicator, which is configured to deposit the conductive material on the substrates thereby forming conductive traces. The third material reserve configured to supply a solder material to the third material applicator, which is configured to deposit the solder material thereby forming solder points on the first modular electronic component and the second modular electronic component. The directed energy head is configured to heat the solder material so that solder points of the first modular electronic component join solder points of the second modular electronic component. The processor is configured to control the first material applicator, the second material applicator, the third material applicator, and the directed energy head according to a computer-aided design.

Another embodiment is a method of forming a modular electronic assembly. The method includes a step of depositing an additive manufacturing material on a support surface thereby forming substrates of a first modular electronic component and a second modular electronic component. The method further includes a step of depositing a conductive material on the substrates thereby forming conductive traces. The method further includes a step of depositing a solder material on the substrates thereby forming solder points of the first modular electronic component and solder points of the second modular electronic component. The method further includes a step of heating the solder material such that the solder points of the first modular electronic component join solder points of the second electronic component.

Another embodiment is a method of forming a modular electronic assembly. The method includes a step of depositing an additive manufacturing material on a support surface thereby forming substrates of a first modular electronic component and a second modular electronic component. The method further includes a step of forming locking structure between the modular electronic components. The method further includes a step of depositing a conductive material on the substrates thereby forming conductive traces. The method further includes a step of embedding some of the conductive material in the substrates. The method further includes a step of depositing a solder material near sides of the substrates thereby forming solder points of the first modular electronic component and solder points of the second modular electronic component. The method further includes a step of heating the solder material such that the solder points of the first modular electronic component join solder points of the second electronic component, with at least one set of joined solder points being electrically isolated from the conductive traces. The method further includes a step of actively cooling the heated solder material. The method further includes a step of reheating the solder material thereby separating the joined solder points.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a computer modeling and additive manufacturing system and a modular electronic assembly constructed in accordance with an embodiment of the present invention;

FIG. 2 is an end elevation view of certain components of the computer modeling and additive manufacturing system of FIG. 1 and a modular electronic component constructed in accordance with an embodiment of the invention;

FIG. 3 is a top plan view of modular electronic components constructed in accordance with an embodiment of the invention;

FIG. 4 is a top plan view of modular electronic components constructed in accordance with an embodiment of the invention;

FIG. 5 is a top plan view of modular electronic components constructed in accordance with an embodiment of the invention;

FIG. 6 is a perspective view of modular electronic components constructed in accordance with an embodiment of the invention; and

FIG. 7 is a flow diagram of certain method steps of soldering modular electronic components together in accordance with another embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

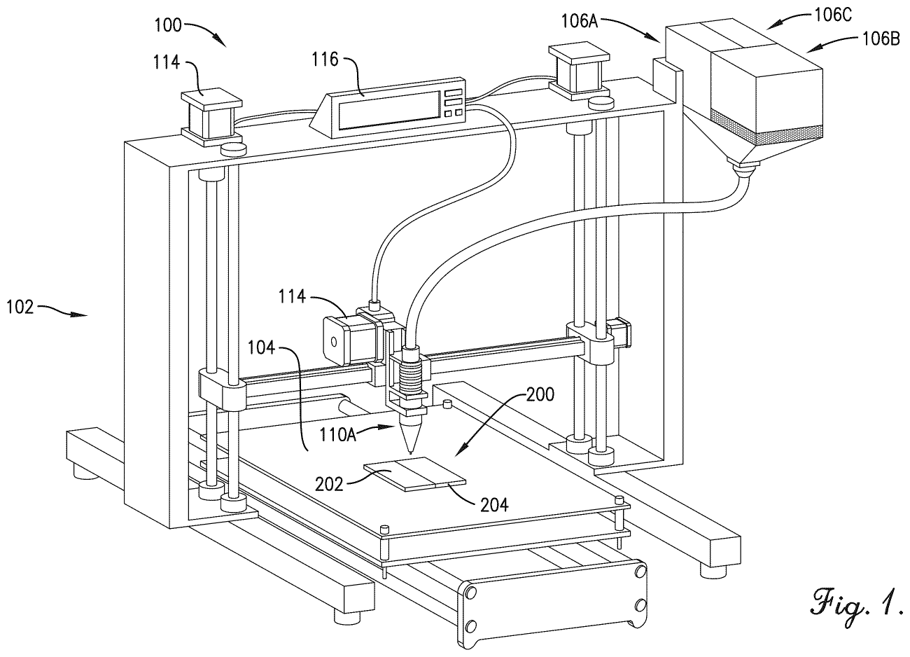

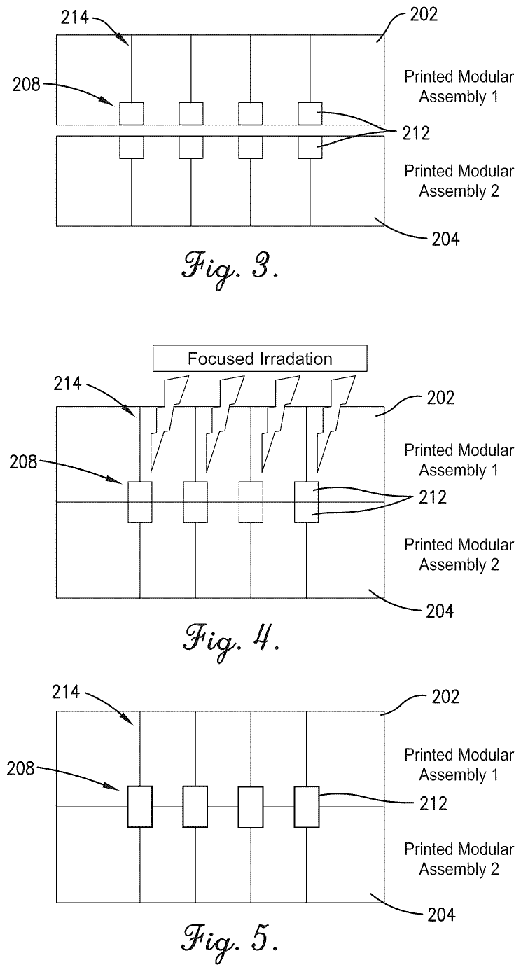

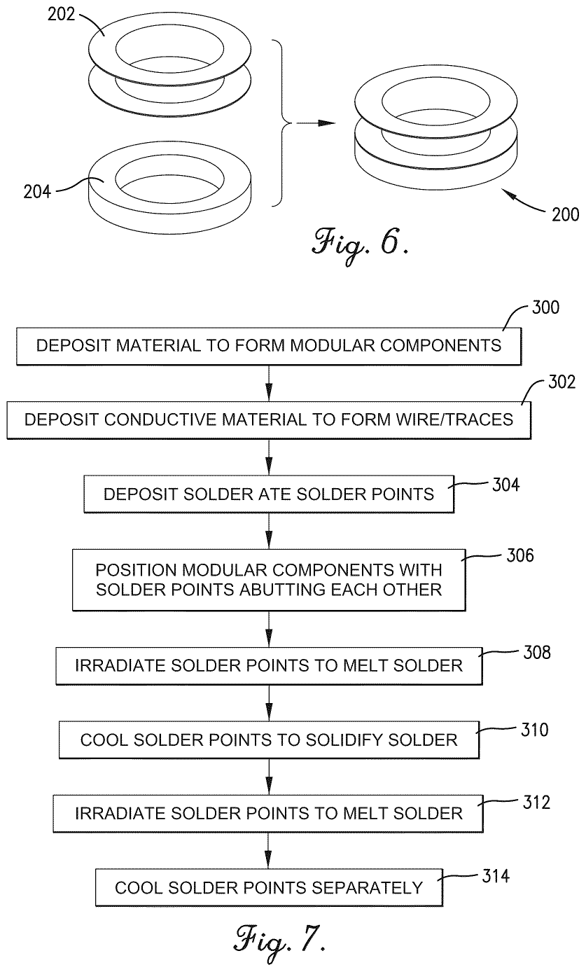

Turning to the drawing figures, and particularly FIGS. 1-6, an additive manufacturing system 100 for producing modular electronic components and/or joining them together to form modular assemblies will now be described in detail. The additive manufacturing system 100 broadly includes a frame 102, a support surface 104, a plurality of material reserves 106A-C, a plurality of feeders 108A-C, a plurality of material applicators 110A-C, a directed energy head 112, a set of motors 114, and a processor 116. For illustrative purposes, the additive manufacturing system 100 is shown producing modular electronic components 202, 204 and joining them together to form a modular assembly 200.

The frame 102 provides structure for the support surface 104, material reserves 106A-C, the feeders, material applicators 110A-C, directed energy head 112, motors 114, and/or the processor 116 and may include a base, vertical members, cross members, and mounting points for mounting the above components thereto. Alternatively, the frame 102 may be a walled housing or similar structure.

The support surface 104 supports the modular electronic components 202, 204, or modular assembly 200 as it is being constructed and may be a stationary or movable flat tray or bed, a substrate, a mandrel, a wheel, scaffolding, or similar support. The support surface 104 may be integral with the additive manufacturing system 100 or may be removable and transferable with the modular assembly 200 or modular electronic components 202, 204 as they are being constructed.

The material reserves 106A-C retain additive manufacturing material 210 and each may be a hopper, tank, cartridge, container, spool, or other similar material holder. The material reserves 106A-C may be integral with the additive manufacturing system 100 or may be disposable and/or reusable.

The additive manufacturing material 210 may be used for forming part 100 and may be in pellet or powder form, filament or spooled form, or any other suitable form. The additive manufacturing material 210 may be any plastic, polymer, or organic material suitable for use in additive manufacturing. For example, the additive manufacturing material 210 may be acrylonitrile butadiene styrene (ABS), polyamide, composites, or other similar material.

The feeder directs the additive manufacturing material 210 to the material applicator 110 and may be a spool feeder, a pump, an auger, or any other suitable feeder. Alternatively, the additive manufacturing material 210 may be gravity fed to the material applicator 110.

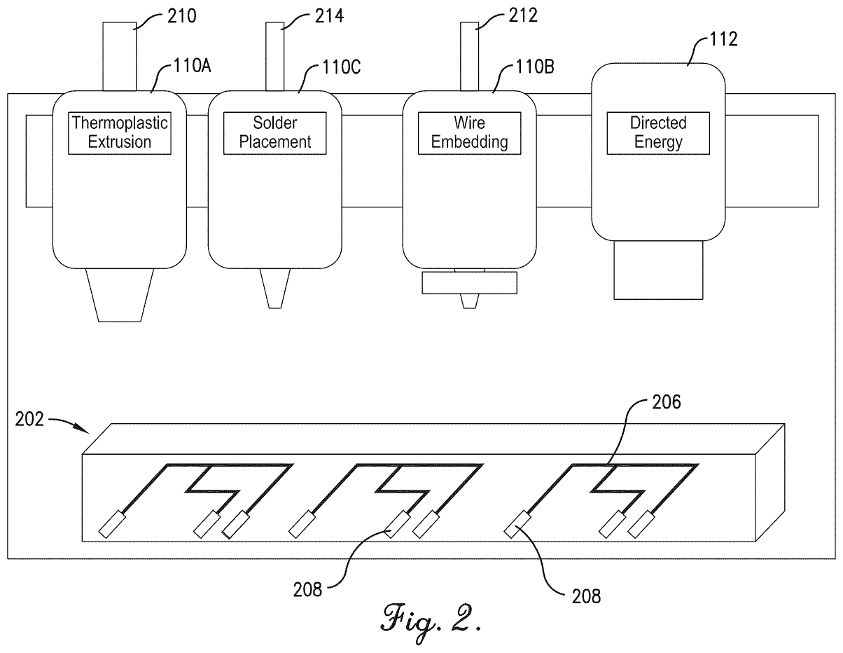

As seen in FIG. 2, the material applicator 110A deposits the additive manufacturing material 210 onto the support surface 104 and previously constructed layers. The material applicator 110A may include a nozzle, guide, sprayer, or other similar component for channeling the additive manufacturing material 210 toward the support surface 104.

The material applicator 110B deposits wire or other conductive material 214. The material applicator 110B may include a nozzle, guide, sprayer, or other similar component for channeling the wire or other conductive material 214 toward the support surface 104.

The material applicator 110C deposits solder 212 onto previously constructed layers near ends of traces 206 to form reflowable solder points 208. The material applicator 110C may include a nozzle, guide, sprayer, or other similar component for channeling the solder 212 toward the support surface 104.

The directed energy head 112 may be a laser, heater, or similar component for melting the additive manufacturing material 210 and bonding (e.g., sintering) the additive manufacturing material 210 onto a previously constructed layer. The directed energy head 112 may utilize microwave, radio frequency (RF), laser energy, or any other suitable form of energy.

The material applicators 110A-C and/or directed energy head 112 may be co-mounted on the frame 102. Alternatively, they may be swappable depending on the function being performed.

Turning again to FIG. 1, the motors 114 position the material applicator 110 over the support surface 104 and previously constructed layers and move the material applicator 110 as the additive manufacturing material 210 is deposited onto the support surface 104 and the previously constructed layers. The motors 114 may be oriented orthogonally to each other so that a first one of the motors 114 is configured to move the material applicator 110 in a lateral “x” direction, a second one of the motors 114 is configured to move the material applicator 110 in a longitudinal “y” direction, and a third one of the motors 114 is configured to move the material applicator 110 in an altitudinal “z” direction. Alternatively, the motors 114 may move the support surface 104 (and hence the part 100) while the material applicator 110 remains stationary.

The processor 116 directs the material applicator 110 via the motors 114 and activates the material applicator 110 such that the material applicator 110 deposits the additive manufacturing material 210 onto the support surface 104 and previously constructed layers according to a computer aided design of the part. The processor 116 may include a circuit board, memory, display, inputs, and/or other electronic components such as a transceiver or external connection for communicating with a processor of a CAD system or other external computing devices.

The processor 116 may implement aspects of the present invention with one or more computer programs stored in or on computer-readable medium residing on or accessible by the processor. Each computer program preferably comprises an ordered listing of executable instructions for implementing logical functions in the processor 116. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

It will be understood that the additive manufacturing system 100 may be any type of additive manufacturing or “3D printing” system such as a sintering, laser melting, laser sintering, extruding, fusing, stereolithography, extrusion, light polymerizing, powder bed, wire additive, or laminated object manufacturing system. The additive manufacturing system 100 may also be a hybrid system that combines additive manufacturing with molding, scaffolding, and/or other subtractive manufacturing or assembly techniques. The additive manufacturing system 100 may also be a multi-axis system. The additive manufacturing system 100 may be able to print or form electrical or electronic circuits, sensors, and/or other electrical or electronic components. The electronic circuits and the like may be embedded in the substrate formed by additive manufacturing material 210.

Turning to FIG. 7 and with reference to FIGS. 1-6, use of the additive manufacturing system 100 for forming modular assemblies and soldering them together will now be described in more detail. First, the additive manufacturing system 100 may deposit material 210 layer by layer onto the support surface 104 to form components 202, 204 of the modular assembly 200, as shown in block 300. To that end, the processor 116 may instruct the motors 114 to move the applicator 110A and may instruct the feeder 108A to direct material 210 to the applicator 110A so that the applicator 110A deposits the material 210 according to a computer model of the component being constructed. The processor 116 may also instruct the motors 114 to move the directed energy head 112 and activate the directed energy head 112 to heat the material 210.

The additive manufacturing system 100 may further deposit or dispense wire 214 or other conductive material to form embedded wires or traces 206, as shown in block 302. To that end, the processor 116 may instruct the motors 114 to move the applicator 110B and may instruct the feeder 108B to direct wire 214 to the applicator 110B so that the applicator 110B deposits the wire 214 according to the computer model. The processor 116 may also instruct the motors 114 to move the directed energy head 112 and activate the directed energy head 112 to heat the wire 214 as needed.

The additive manufacturing system 100 may also deposit solder 212 to form reflowable solder points 208 (solder pads, or solder plugs), as shown in block 304. To that end, the processor 116 may instruct the motors 114 to move the applicator 110C and may instruct the feeder 108C to direct solder 212 to the applicator 110C so that the applicator 110C deposits the solder 212 according to the computer model. The solder points 208 may be positioned near ends of the traces 206 with the solder points 208 being electrically connected to the traces 206. The solder points 208 may also be prominent (e.g., near sides, edges, or ends of the modular electronic components 202, 204 so that they can abut corresponding solder points of other modular electronic components.

At this point, the modular electronic components 202, 204 may themselves be complete and ready to be soldered together to form modular assembly 200, soldered to other components, and/or incorporated into larger assemblies via the additive manufacturing system 100, as described below. Alternatively, the modular electronic components 202, 204 may be stocked or sold for later use, reused, or the like.

The modular electronic components 202, 204 may be placed so that the solder points 208 abut each other, as shown in block 306. In one embodiment, the modular electronic components 202, 204 may be formed with the corresponding solder points 208 abutting each other.

The additive manufacturing system 100 may then meld the corresponding solder points 208 together via irradiation, as shown in block 308. To that end, the processor 116 may instruct the motors 114 to move the directed energy head 112, and activate the directed energy head 112 to melt the solder points 208 such that the solder 212 of adjacent solder points 208 melts and flows together.

Upon cessation of energy being directed at the solder points 208, the melted solder 212 may be cooled (either via active cooling or passive cooling), as shown in block 310. The solder 212 may thereby solidify, thus creating a robust permanent interface therebetween. Additional features may be formed to provide physical/mechanical joining or locking features (i.e., locking structure). To that point, solder points may be purely physical/mechanical joining or locking features and not have electrical or electronic function.

The joined modular electronic components 202, 204 may now be treated as a single component/assembly and utilized as such, soldered to other components, and/or incorporated into larger assemblies. If at any time the joined modular electronic components 202, 204 need to be temporarily or permanently separated, such as for replacing worn-out or defective components or for upgrading components, the additive manufacturing system 100 (or another device) may melt the joined solder points 208 via additional irradiation, as shown in block 312. To that end, the processor 116 may instruct the motors 114 to move the directed energy head 112, and activate the directed energy head 112 to melt the solder points 208 such that the solder 212 of the joined solder points 208 melts.

Upon cessation of energy being directed at the joined solder points 208, the melted solder 212 may be cooled (either via active cooling or passive cooling) separately, as shown in block 314. To that end, the modular electronic components 202, 204 may be spaced apart from each other or at least the solder 212 of joined solder points 208 may be partitioned so that the solder points 208 do not solidify together. The solder 212 on individual solder points 208 may thereby solidify separately, thus completing separation of the modular electronic components 202, 204. Alternatively, the solder 212 may be removed from the modular electronic components 202, 204 when the solder 212 is flowable to separate the modular electronic components 202, 204. This eliminates the need to space apart the modular electronic components 202, 204 or partition the solder 212, but it requires new or recycled solder 212 to be deposited on the solder point 208 if the modular electronic components 202, 204 are to be joined again.

Solder points 208 may also be left as separate contact points (i.e., solder 212 may be deposited and cooled on individual solder points without joining) for initial testing. For example, the solder points 208 may be formed as complementary “pad and pin” structures to allow rapid assembly and disassembly of modular electronic components. This leaves the option for joining the modular electronic components via the above method at a later time.

The above-described invention provides several advantages. For example, the modular electronic components 202, 204 may be connector-free (i.e., part-as-connector), which eliminates the need for connectors and cables. This increases compactness, ensures a robust electrical connection, and eliminates or reduces failure points. Component creation and joining can be performed via a single additive manufacturing system 100. Aspects of component joining can also be incorporated into CAD processes, which increases predictability of part quality and performance. Similarly, selective soldering (i.e., choosing which solder points to solder) and soldering parameters or variables can be manipulated via CAD data, which can more easily be adjusted or changed. Directed energy for soldering the solder points 208 can take many forms including microwave, RF, and laser sources. The modular electronic components 202, 204 can also be easily separated via the additive manufacturing system 100 or via another directed energy source. Furthermore, the modular electronic components 202, 204 can assume a pad/pin configuration for initial testing.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processing elements need not be configured or instantiated at any one instance in time. For example, where the processor comprises a general-purpose processor configured using software, the general-purpose processor may be configured as respective different processing elements at different times. Software may accordingly configure the processor to constitute a particular hardware configuration at one instance of time and to constitute a different hardware configuration at a different instance of time.

Computer hardware components, such as communication elements, memory or memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory or memory device to which it is communicatively coupled. A further computer hardware component may then, at a later time, access the memory to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processors or processing element-implemented hardware modules. The performance of certain of the operations may be distributed among the one or more processing elements or processors, not only residing within a single machine, but deployed across a number of machines. In some example embodiments, the processor or processing elements may be located in a single location (e.g., within a home environment, an office environment or as a server farm), while in other embodiments the processor or at least some of its processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the invention has been described with reference to the embodiments illustrated in the attached drawing figures, it is noted that equivalents may be employed and substitutions made herein without departing from the scope of the invention as recited in any claims ensuing from this provisional patent application.

Having thus described various embodiments of the technology, what is claimed as new and desired to be protected by Letters Patent includes the following:

1. An additive manufacturing system configured to form a modular electronic assembly including a first modular electronic component and a second modular electronic component, the additive manufacturing system comprising:
a frame;
a support surface positioned on the frame;
a first material reserve configured to supply an additive manufacturing material;
a first material applicator configured to deposit the additive manufacturing material to form substrates of the first modular electronic component and the second modular electronic component on the support surface;
a second material reserve configured to supply a conductive material;
a second material applicator configured to deposit the conductive material on the substrates thereby forming conductive traces;
a third material reserve configured to supply a solder material;
a third material applicator configured to deposit the solder material thereby forming solder points on the first modular electronic component and the second modular electronic component;
a directed energy head configured to heat the solder material so that solder points of the first modular electronic component join solder points of the second modular electronic component; and
a processor configured to control the first material applicator, the second material applicator, the third material applicator, and the directed energy head according to a computer-aided design.

2. The additive manufacturing system of claim 1, wherein at least one set of joined solder points is electrically isolated from the conductive traces.

3. The additive manufacturing system of claim 1, wherein the third material applicator is configured to deposit the solder material near sides of the substrates.

4. The additive manufacturing system of claim 1, wherein the third material applicator is configured to deposit the solder material near edges of the substrates.

5. The additive manufacturing system of claim 1, wherein the third material applicator is configured to deposit the solder material near ends of the substrates.

6. The additive manufacturing system of claim 1, wherein the additive manufacturing system is configured to embed some of the conductive material in the substrates.

7. The additive manufacturing system of claim 1, wherein the conductive material is a wire.

8. The additive manufacturing system of claim 1, further configured to form locking structure between the modular electronic components.

9. A method of forming a modular electronic assembly, the method comprising steps of:
depositing an additive manufacturing material on a support surface thereby forming substrates of a first modular electronic component and a second modular electronic component;
depositing a conductive material on the substrates thereby forming conductive traces;
depositing a solder material on the substrates thereby forming solder points of the first modular electronic component and solder points of the second modular electronic component; and
heating the solder material such that the solder points of the first modular electronic component join solder points of the second electronic component.

10. The method of claim 9, wherein at least one set of joined solder points is electrically isolated from the conductive traces.

11. The method of claim 9, wherein the depositing solder material step includes depositing the solder material near sides of the substrates.

12. The method of claim 9, wherein the depositing solder material step includes depositing the solder material near edges of the substrates.

13. The method of claim 9, wherein the depositing solder material step includes depositing the solder material near ends of the substrates.

14. The method of claim 9, wherein the depositing additive manufacturing material and depositing conductive material steps include embedding some of the conductive material in the substrates.

15. The method of claim 9, wherein the conductive material is a wire.

16. The method of claim 9, further comprising a step of forming locking structure between the modular electronic components.

17. The method of claim 9, further comprising a step of reheating the solder material thereby separating the joined solder points.

18. The method of claim 9, further comprising a step of actively cooling the heated solder material.

19. The method of claim 9, further comprising a step of modifying soldering parameters via computer aided design (CAD) data.

20. A method of forming a modular electronic assembly, the method comprising steps of:
depositing an additive manufacturing material on a support surface thereby forming substrates of a first modular electronic component and a second modular electronic component;
forming locking structure between the modular electronic components;
depositing a conductive material on the substrates thereby forming conductive traces;
embedding some of the conductive material in the substrates;
depositing a solder material near sides of the substrates thereby forming solder points of the first modular electronic component and solder points of the second modular electronic component,
at least one set of joined solder points being electrically isolated from the conductive traces;
heating the solder material such that the solder points of the first modular electronic component join solder points of the second electronic component; and
actively cooling the heated solder material.
